(19) United States
(12) Patent Application Publication
(10) Pub. No.: US 2019/0319379 A1
(43) Pub. Date: Oct. 17, 2019

(54) HIGH-RATE SIGNAL CONNECTOR MODULE

(71) Applicant: PEGATRON CORPORATION, TAIPEI CITY (TW)

(72) Inventors: Ping-Yi LIN, TAIPEI CITY (TW); Chia-Hsing YU, TAIPEI CITY (TW); Wei-Hsiang LEE, TAIPEI CITY (TW)

(21) Appl. No.: 16/365,930

(22) Filed: Mar. 27, 2019

(30) Foreign Application Priority Data
Apr. 11, 2018 (TW) 107112435

(51) Int. Cl. H01R 12/70; H01R 13/66

(52) U.S. Cl. CPC H01R 12/7076; H01R 13/6658

(57) ABSTRACT

A high-rate signal connector module is disposed on a circuit board and includes a metal housing, an electrical coupling component, and a carrier, where the metal housing has an accommodating space for accommodating the electrical coupling component and the carrier, at least one electrical protection element is disposed on the carrier, and a part of the metal housing is located between the carrier and the circuit board. By means of configurations of various elements of the present invention, attenuation of high-rate signals and radio wave signals can be effectively reduced.

### CROSS-REFERENCE TO RELATED APPLICATION

This application claims priority to Taiwan Application Serial Number 107112435, filed on Apr. 11, 2018, which is herein incorporated by reference in its entirety.

### BACKGROUND

### Technical Field

The disclosure relates to a high-rate signal connector module, and in particular, to an integrated connector module having an electronic protection element.

### Related Art

Protection of electrostatic discharge (ESD) and electromagnetic interference (EMI) is very important for precise electronic devices. By means of configurations of these protection elements, in addition to protecting the electronic devices from an electrostatic damage, signal attenuation caused by electromagnetic waves in the electronic devices is also reduced.

However, when a high-rate signal is routed to a connector currently, the high-rate signal needs to be routed to ESD and EMI protection elements on a surface of a circuit board, and then continues to be routed to the connector. Because electromagnetic wave radiation of the high-rate signal and a radio frequency (RF) signal are in the same frequency band, the high-rate signal through the surface routing easily resonates with the RF signal, resulting in interference with each other and signal attenuation.

Therefore, how to provide a connector module that can resolve the foregoing problems is an urgent issue that the current industry is eager to invest in resources.

### SUMMARY

In view of this, an objective of the present invention is to provide an integrated high-rate signal connector module to resolve problems of an additional routing and derivative issues of conventional connectors.

To achieve the foregoing objective, according to an implementation of the present invention, a high-rate signal connector module disposed on a circuit board is provided, including a metal housing, an electrical coupling component, and a carrier. The metal housing has an accommodating space for accommodating the electrical coupling component and the carrier. The electrical coupling component passes through the metal housing to be electrically connected to the circuit board. The carrier is coupled to the electrical coupling component and includes at least one electrical protection element. A part of the metal housing is located between the carrier and the circuit board.

In one or more implementations of the present invention, the foregoing electrical coupling component further includes an insulating material and a plurality of conductive members. The plurality of conductive members is embedded in the insulating material, and is at least exposed out of two ends of the insulating material, to respectively serve as connector terminals and circuit board pins.

In one or more implementations of the present invention, the foregoing metal housing includes a hole, and the electrical coupling component is coupled to the circuit board through the hole.

In one or more implementations of the present invention, the foregoing metal housing and the circuit board pins are insulated from each other.

In one or more implementations of the present invention, a type of the foregoing at least one electrical protection element includes any one or combination of an electrostatic protection element and an electromagnetic shielding element.

In one or more implementations of the present invention, the foregoing metal housing further includes a grounding unit electrically connected to a grounding end of the circuit board.

In one or more implementations of the present invention, a length direction of the foregoing electrical coupling component is parallel to the circuit board.

In one or more implementations of the present invention, the foregoing carrier is parallel to the length direction of the electrical coupling component.

In one or more implementations of the present invention, the foregoing carrier is perpendicular to the length direction of the electrical coupling component.

In one or more implementations of the present invention, the foregoing carrier is detachably connected to the electrical coupling component.

In conclusion, the metal housing and the carrier are configured in the high-rate signal connector module of the present invention. The metal housing with a high cover ratio can isolate interference of various electromagnetic waves. The electrical protection element is disposed on the carrier, and the carrier is integrated in the high-rate signal connector module, that is, the plurality of elements is integrated into a single part, so that a routing distance and the number of layer changes of a high-rate signal are reduced, thereby reducing attenuation of the high-rate signal and a radio wave signal. An entire high-rate signal routing is disposed in an inner layer of the circuit board and the metal housing of the high-rate signal connector module, thereby further reducing the attenuation of the high-rate signal. Therefore, the high-rate signal connector module of the present invention can resolve problems of signal interference and signal attenuation in the conventional art by using the foregoing unique element configurations.

The foregoing description is merely intended to illustrate the problems to be resolved, the technical means for resolving the problems, the effects thereof, and the like. Specific details of the present invention are described in detail in the following implementations and related drawings.

### BRIEF DESCRIPTION OF THE DRAWINGS

To make the foregoing and other objectives, features, advantages, and embodiments of the present invention more comprehensible, the accompanying drawings are described below.

FIG. 1 is a cross-sectional view of a high-rate signal connector module according to an implementation of the present invention;

FIG. 2 is a cross-sectional view of a high-rate signal connector module according to another implementation of the present invention; and

FIG. 3 is a cross-sectional view of a high-rate signal connector module according to still another implementation of the present invention.

### DETAILED DESCRIPTION

A plurality of implementations of the present invention are disclosed below with reference to the drawings, and for the sake of clarity, many practical details are described below in the following description. However, it should be understood that, these practical details are not intended to limit the present invention. That is, in part of implementations of the present invention, these practical details are not necessary. In addition, to simplify the drawings, some conventional structures and components are illustrated in the drawings in a simplified schematic manner.

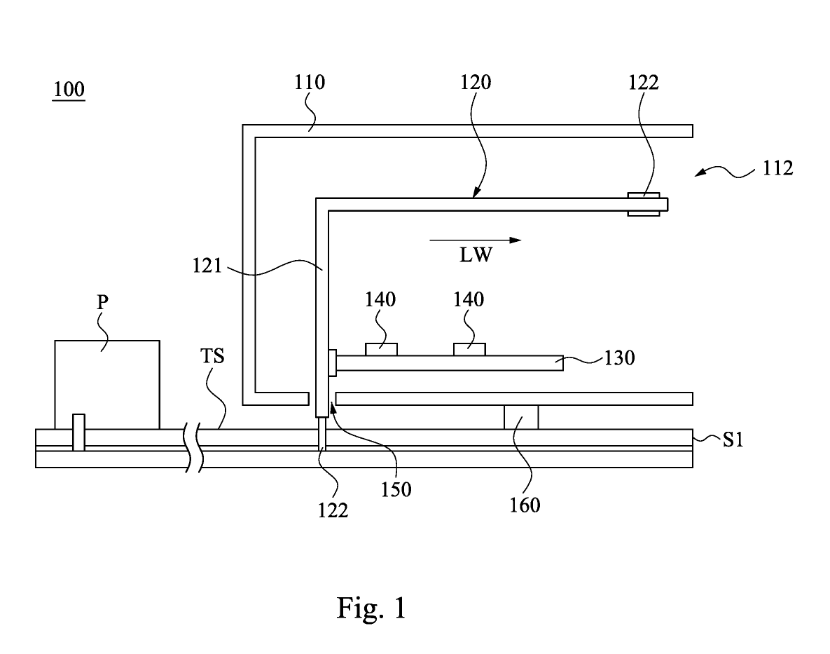

FIG. 1 is a cross-sectional view of a high-rate signal connector module according to an implementation of the present invention. The high-rate signal connector module 100 is disposed on a circuit board S1, and includes a metal housing 110, an electrical coupling component 120, and a carrier 130. The metal housing 110 defines an accommodating space 112 for accommodating the electrical coupling component 120 and the carrier 130. The carrier 130 is coupled to the electrical coupling component 120, and includes at least one electrical protection element 140 disposed on the carrier 130. A part of the metal housing 110 is located between the carrier 130 and the circuit board S1. The electrical coupling component 120 has a length direction LW parallel to a top surface TS of the circuit board S1.

Specifically, in an implementation of the present invention, the carrier 130 is connected to the electrical coupling component 120 by using solder. In this way, a physical support is provided for the carrier 130, and the carrier 130 is electrically connected to the electrical coupling component 120 for signal transmission therebetween. However, a manner in which the carrier 130 is coupled to the electrical coupling component 120 of the present invention is not limited thereto. Relative positions of the carrier 130 and the electrical coupling component 120 are also not specifically limited, including being perpendicular or parallel to each other, provided that the carrier 130 does not affect operation of the high-rate signal connector module 100. For example, when an external connector is inserted into the high-rate signal connector module 100, a position of the carrier 130 at least needs to be not interfered with the external connector.

The metal housing 110 substantially includes a plurality of plates, such as a top plate, a bottom plate, a side plate, and the like. As shown in FIG. 1, the bottom plate of the metal housing 110 is located between the carrier 130 and the circuit board S1, so that the metal housing 110 can reduce signal interference between the electrical protection elements 140 on the carrier 130 and the circuit board S1. Therefore, strength of a signal can be maintained.

The electrical coupling component 120 further includes an insulating material 121 and a plurality of conductive members 122. The insulating material 121 wraps the conductive members 122, so that the conductive members 122 are embedded. The plurality of conductive members is at least exposed out of two ends of the insulating material 121 to serve as connector terminals to be connected to the external connector and serve as circuit board pins to be connected to the circuit board S1, to transmit the high-rate signal therebetween.

The metal housing 110 further includes a hole 150. As shown in FIG. 1, the hole 150 is located on the bottom plate of the metal housing 110, so that the electrical coupling component 120 can pass through the hole 150 to be connected to the circuit board S1.

It should be noted that the circuit board pins passing through the metal housing 110 is insulated from the metal housing 110, that is, when the circuit board pins passing through the metal housing 110 is wrapped by the insulating material 121, the circuit board pins and the metal housing 110 are insulated from each other due to separation by the insulating material 121. Alternatively, when there is a gap between the circuit board pins passing through the metal housing 110 and the metal housing 110, the circuit board pins and the metal housing 110 are also insulated from each other because the circuit board pins and the metal housing 110 are not in direct contact with each other. However, a setting manner of the metal housing 110 and the circuit board pins in the present invention is not limited thereto, for example, the foregoing two insulating methods can be randomly combined according to different purposes.

According to another aspect, a type of the at least one electrical protection element includes any one or combination of an electrostatic protection element and an electromagnetic shielding element. An ESD protection element can protect the high-rate signal connector module 100 from being damaged by static electricity and sudden charge fluctuations, and an EMI protection element can reduce internal-to-external and external-to-internal electromagnetic radiation interference of the high-rate signal connector module 100, so that strength of the high-rate signal is maintained. Therefore, a user can freely select, according to different purposes, an electrical protection element 140 to be disposed on the carrier 130.

The metal housing 110 further includes a grounding unit 160. The grounding unit 160 may be an integrally formed extension a part of the metal housing 110, and may alternatively be an independent element with electrical conductivity. The grounding unit 160 is electrically connected to a grounding end of the circuit board S1, so that the metal housing 110 has functions of electrical protection and electromagnetic interference prevention.

In addition, in an implementation of the present invention, the high-rate signal connector module 100 is disposed on the circuit board S1 in a dual in-line package (DIP) manner. However, a connection manner of the high-rate signal connector module 100 of the present invention is not limited thereto. For example, the connection manner of the high-rate signal connector module 100 can alternatively be implemented by using a surface mount technology (SMT).

It should be noted that when the external connector is coupled to the high-rate signal connector module 100 of the present invention by using the plurality of conductive members 122, a high-rate signal is transmitted back and forth among the external connector, the electrical coupling component 120, the carrier 130, an inner layer of the circuit board S1, and a high-frequency signal processor P. In the present invention, the electrical protection element 140 and other elements are integrated into a single part. Therefore, a routing distance and layer change actions of the signal are reduced, thereby achieving an effect of reducing the interference and the attenuation of the high-rate signal. In addition, the metal housing 110 of the present invention covers other elements, and an effect of reducing the internal-to-external and external-to-internal electromagnetic radiation interference is achieved due to a shielding effect of the metal housing 110. Therefore, the high-rate signal connector module 100 of the present invention can resolve the problems of the high-rate signal attenuation and the electromagnetic radiation interference by using the foregoing various element configurations.

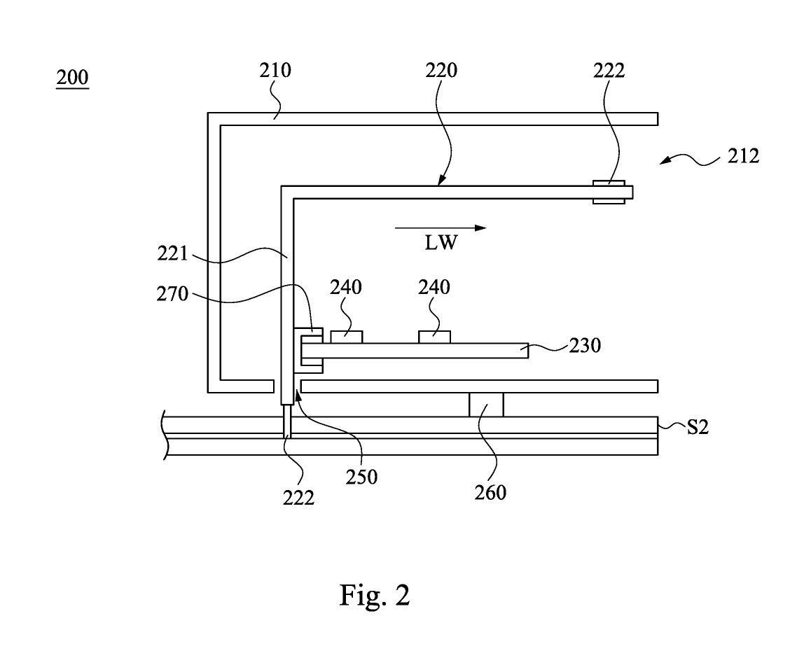

FIG. 2 is a cross-sectional view of a high-rate signal connector module according to another implementation of the present invention. The high-rate signal connector module 200 is disposed on a circuit board S2, and includes a metal housing 210, an electrical coupling component 220, and a carrier 230. The electrical coupling component 220 further includes an insulating material 221 and a plurality of conductive members 222. The carrier 230 further includes at least one electrical protection element 240 disposed on the carrier 230. The metal housing 210 defines an accommodating space 212 and includes a hole 250 and a grounding unit 260. In this implementation, the metal housing 210, the accommodating space 212, the electrical coupling component 220, the insulating material 221, the plurality of conductive members 222, the at least one electrical protection element 240, the grounding unit 260, and the circuit board S2 are the same as those in the implementation shown in FIG. 1. Therefore, reference may be made to the foregoing related description, and details are not described herein again.

In another implementation of the present invention, the carrier 230 is detachably connected to the electrical coupling component 220. Specifically, the electrical coupling component 220 has a coupling element 270 thereon, so that the carrier 230 is detachably connected to the electrical coupling component 220 by using the coupling element 270. The coupling element 270 may be an edge connector (which is commonly referred to as a “gold finger” connector), so that the carrier 230 can be detached from or assembled to the electrical coupling element 270 by using the coupling element 270 like card insertion. Therefore, the user can further detach or assemble the carriers with different electronic protection elements according to different purposes to perform expansion applications in accordance with the purposes. For example, the user can choose to assemble a carrier with a 4-KV, 8-KV, or 12-KV ESD/EMI electronic protection element. However, a type of the coupling element 270 of the present invention is not limited thereto.

In addition, as shown in FIG. 2, the carrier 230 is connected to the electrical coupling component 220 by using the coupling element 270, so that the carrier 230 is disposed parallel to a length direction LW of the electrical coupling component 220.

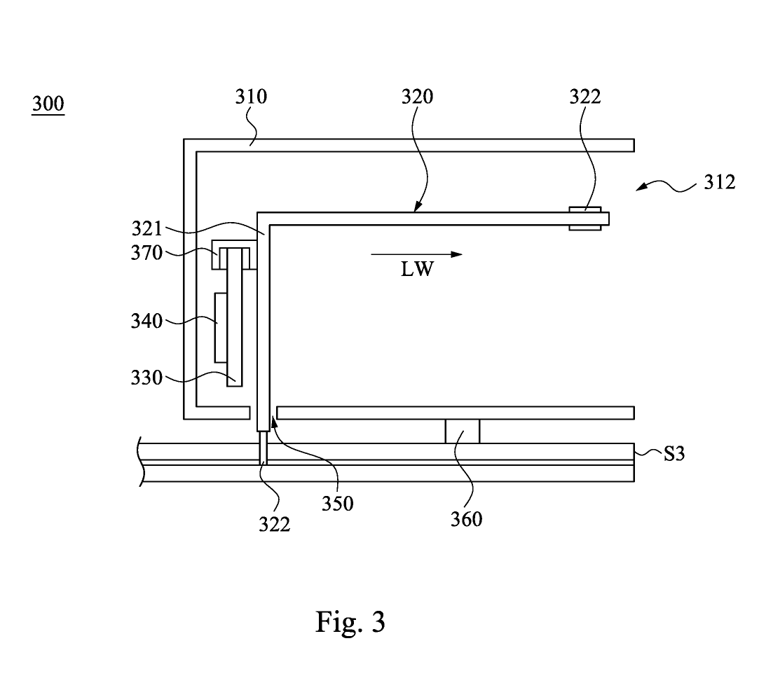

FIG. 3 is a cross-sectional view of a high-rate signal connector module according to still another implementation of the present invention. The high-rate signal connector module 300 is disposed on a circuit board S3, and includes a metal housing 310, an electrical coupling component 320, and a carrier 330. The electrical coupling component 320 further includes an insulating material 321 and a plurality of conductive members 322. The carrier 330 further includes at least one electrical protection element 340 disposed on the carrier 330. The metal housing 310 defines an accommodating space 312 and includes a hole 350 and a grounding unit 360. In this implementation, the metal housing 310, the accommodating space 312, the electrical coupling component 320, the insulating material 321, the plurality of conductive members 322, the at least one electrical protection element 340, the grounding unit 360, and the circuit board S2 are the same as those in the implementation shown in FIG. 1. Therefore, reference may be made to the foregoing related description, and details are not described herein again.

In addition, a coupling element 370 of this embodiment is the same as that in the implementation shown in FIG. 2. Therefore, reference may be made to the foregoing related description, and details are not described herein again. It should be noted that, the carrier 330 is connected to the electrical coupling component 320 by using the coupling element 370, so that the carrier 330 is disposed perpendicular to a length direction LW of the electrical coupling component 320.

It should be noted that, in one or more implementations of the present invention, a type of the high-rate signal connector module is a USB Type-C in universal serial buses (USB). However, the type of the high-rate signal connector module is not limited thereto. For example, the type of the high-rate signal connector module can alternatively be a USB Type-A, a USB Type-B, or other types of connectors.

According to the foregoing detailed description of specific implementations of the invention, the metal housing and the carrier are configured in the high-rate signal connector module of the present invention. The metal housing with a high cover ratio can isolate the interference of various electromagnetic waves. The electrical protection element is disposed on the carrier, and the carrier is integrated in the high-rate signal connector module, that is, the foregoing plurality of elements is integrated into a single part, so that the routing distance and the number of layer changes of the high-rate signal are reduced, thereby reducing the attenuation of the high-rate signal and the radio wave signal. The entire high-rate signal routing is disposed in the inner layer of the circuit board and the metal housing of the high-rate signal connector module, thereby further reducing the attenuation of the high-rate signal. Therefore, the high-rate signal connector module of the present invention can resolve the problems of the signal interference and the signal attenuation in the conventional art by using the foregoing unique element configurations.

Although the present invention discloses the implementations as above, the above implementations are not intended to limit the present invention. Person skilled in the art can make various variations and modifications without departing from the spirit and the scope of the present invention. Therefore, the protection scope of the present invention shall be subject to the appended claims.

What is claimed is:

1. A high-rate signal connector module, disposed on a circuit board, comprising:
a metal housing, having an accommodating space;
an electrical coupling component, disposed inside the accommodating space and passing through the metal housing to be electrically connected to the circuit board; and
a carrier, coupled to the electrical coupling component, and comprising at least one electrical protection element, wherein a part of the metal housing is located between the carrier and the circuit board.

2. The high-rate signal connector module according to claim 1, wherein the electrical coupling component further comprises:
an insulating material; and
a plurality of conductive members, partially embedded in the insulating material, and at least exposed out of two ends of the insulating material, to respectively serve as connector terminals and circuit board pins.

3. The high-rate signal connector module according to claim 1, wherein the metal housing comprises a hole, and the electrical coupling component is coupled to the circuit board through the hole.

4. The high-rate signal connector module according to claim 2, wherein the metal housing and the circuit board pins are insulated from each other.

5. The high-rate signal connector module according to claim 1, wherein a type of the at least one electrical protection element comprises any one or combination of an electrostatic protection element and an electromagnetic shielding element.

6. The high-rate signal connector module according to claim 1, wherein the metal housing further comprises a grounding unit electrically connected to a grounding end of the circuit board.

7. The high-rate signal connector module according to claim 1, wherein a length direction of the electrical coupling component is parallel to the circuit board.

8. The high-rate signal connector module according to claim 7, wherein the carrier is parallel to the length direction of the electrical coupling component.

9. The high-rate signal connector module according to claim 7, wherein the carrier is perpendicular to the length direction of the electrical coupling component.

10. The high-rate signal connector module according to claim 1, wherein the carrier is detachably connected to the electrical coupling component.
